(19) United States
(12) Patent Application Publication
(10) Pub. No.: US 2006/0098440 A1
(43) Pub. Date: May 11, 2006

(54) Solid state lighting device with improved thermal management, improved power management, adjustable intensity, and interchangable lenses

(76) Inventor: David Allen, Yardley, PA (US)

Correspondence Address: Liniak, Berenato & White, Ste. 240, 6550 Rock Spring Drive, Bethesda, MD, 20817, US

(21) Appl. No.: 11/045,342

(22) Filed: Jan. 31, 2005

Related U.S. Application Data
(60) Provisional application No. 60/625,163, filed on Nov. 5, 2004.

(51) Int. Cl. F21V 29/00

(52) U.S. Cl. 362/294; 362/240; 362/231

(57) ABSTRACT

A solid state (light emitting diode) lamp in numerous configurations have improved thermal management by providing a direct thermal pathway from the plurality of LED chips to the threaded screw base (standard 100˜240 VAC lamp socket), or power coupling. The control circuitry is disposed opposite the printed circuit board and LED chips with respect to the heat sink so that the heat sink is interposed between the printed circuit board and the control circuitry. The LED chips are powered using a high voltage/high current configuration. The light radiation pattern is infinitely adjustable (very wide through very narrow) via a system of easily interchangeable lenses. The solid state lamps can be mass produced rapidly at significantly lower cost with very high luminous intensity. ESD protection may be included to protect the LED chips from electrostatic discharge damage.

This application is a Non-Provisional Patent Application of U.S. Provisional Patent Application No. 60/625,163 filed Nov. 5, 2004, which is hereby incorporated by reference.

### BACKGROUND OF THE INVENTION

1. Field of Invention

The present invention relates to light emitting diode lamps, and more particularly to light emitting diode lamps that can be easily mass produced, have adjustable integrated thermal management systems located outside the enclosing globe or lens, have maximum thermal transfer area between components, are designed to operate at high voltage (100˜240 VAC), are designed to operate at high current, thus higher total power (W), and are capable of high luminous intensity, and have a light beam radiation pattern that is infinitely adjustable.

2. Description of the Prior Art

In the prior art, light emitting diodes (LED's) and other semiconductor light sources have not been successfully or economically used to illuminate physical spaces. Earlier prior art describes LED lights sources as indicator lights, or low intensity arrays using low-voltage coupled with low input current, low voltage coupled with high input current, or high voltage coupled with low input current. All of these early configurations produce a light source with low luminous intensity. In addition, these designs are severely limited due to spatial considerations as the arrangement of the discreet LED arrays required a great deal of physical space.

More recent prior art improves these early designs somewhat as they incorporate some form of thermal management into their design. However, the thermal designs are inadequate, impractical, or both. Most designs call for power conversion from source voltage AC to low voltage DC power adding significant cost and complication to their design while some prior art does not address power, or electrical coupling of components. In addition, much of the prior art focuses on widening the light emission patterns typical of LED light bulbs using discrete components without addressing the need for bulbs of various light emission patterns.

According to the prior art there is still a distinct need for an efficient, self contained semiconductor device capable of producing high intensity visible light with variable light emission patterns and sufficient thermal management to serve as a direct replacement for common incandescent lamps. The present invention addressed the shortcomings and limitations of prior art.

### SUMMARY OF THE INVENTION

It is an object of this invention to obviate the above-mentioned drawbacks and limitations in the prior art. This invention more particularly aims at providing a solid state lighting device (LED lamps) which can be easily mass produced efficiently and at minimum cost, has an easily adjustable light emission pattern, is electrically efficient, is thermally efficient, has a high degree of reliability, requires no external adaptors or power conditioning, can be manufactured in any color of the visible light spectrum, can be manufactured in white including full-spectrum white and color-changing, and is capable of providing uniform lighting with high luminous flux.

It is an object of this invention to provide a direct thermal pathway from the plurality of LED chips to the threaded screw base (100˜240 VAC lamps socket), or power coupling. This is accomplished using substantially 100% contact surface area between the various modular components.

In accordance with these objectives, the invention is a solid-state lamp, comprising: a lighting module (100) including a printed circuit board (102), at least one light emitting diode (LED) chip (101) affixed directly to the printed circuit board (102), and a backer plate (103) contacting the printed circuit board. The backer plate (103) dissipates heat from generated by the at least one LED chip (101) and the printed circuit board (102). A heat sink (105) is affixed to the backer plate (103) of the lighting module (100) in a manner to reduce interstitial air gaps between the heat sink (105) and the backer plate (103). A control circuit (106) is mounted to the heat sink (105) opposite the printed circuit board (102); an electrical interface electrically connects the lighting module (100) to the control circuit (106), and a power coupler (107) is electrically connected to the control circuit (106).

These, as well as other objects of various embodiments of this invention will become apparent to persons of ordinary skill in the art upon reading the specifications, viewing the appended drawings, and reading the claims.

### BRIEF DESCRIPTION OF THE DRAWINGS

FIG. 1a is a typical lighting device in accordance with the present invention;

FIG. 1b shows various, interchangeable screw-on lenses and globes in accordance with the present invention;

FIG. 2a is another example of a typical lighting device in accordance with the present invention;

FIG. 2b shows various, interchangeable screw-on lenses in accordance with the present invention;

FIG. 3a is yet another example of a typical lighting device in accordance with the present invention;

FIG. 3b shows various, interchangeable screw-on lenses in accordance with the present invention;

FIGS. 4a-4c show three embodiments as examples of lighting devices in accordance with the present invention;

FIG. 5 is an enlarged view of the various thermal and modular layers in accordance with the present invention;

FIG. 6 is an enlarged view of surface irregularities common to thermocouples in accordance with the present invention;

FIGS. 7a-7d are examples of schematic circuit diagrams in accordance with the present invention; FIG. 7a is a basic parallel/series circuit; FIG. 7b is a basic series/parallel circuit; FIG. 7c shows a basic current limit circuit; and FIG. 7d shows a constant amplified current circuit;

FIG. 8 is an enlarged view of a typical power diode or power LED;

FIG. 9 is a chart showing typical white LED lifetime as a function of LED case temperature;

FIG. 10 is a chart showing the typical thermal resistance of heavy metal printed circuit board;

FIG. 11 is a heat sink comparison table, illustrating thermal gain (° C./W) using large; Pre-engineered heat sinks as a function of power;

FIG. 12 is a flow chart illustrating the principals of matching luminous intensity with power (Wattage), with the adjustable thermal management and design components in accordance with the present invention.

### DETAILED DESCRIPTION OF PREFERRED EMBODIMENTS

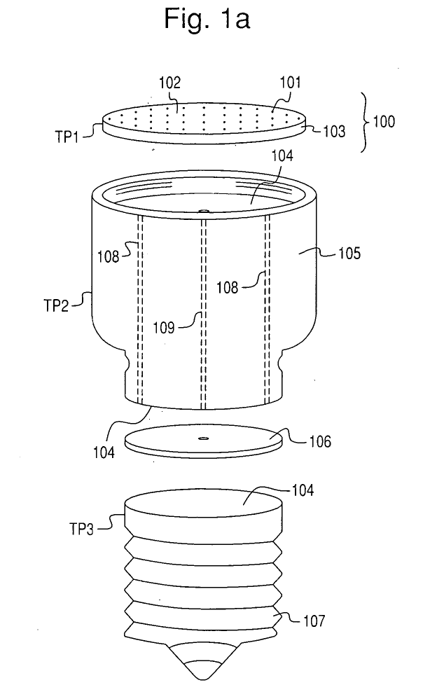

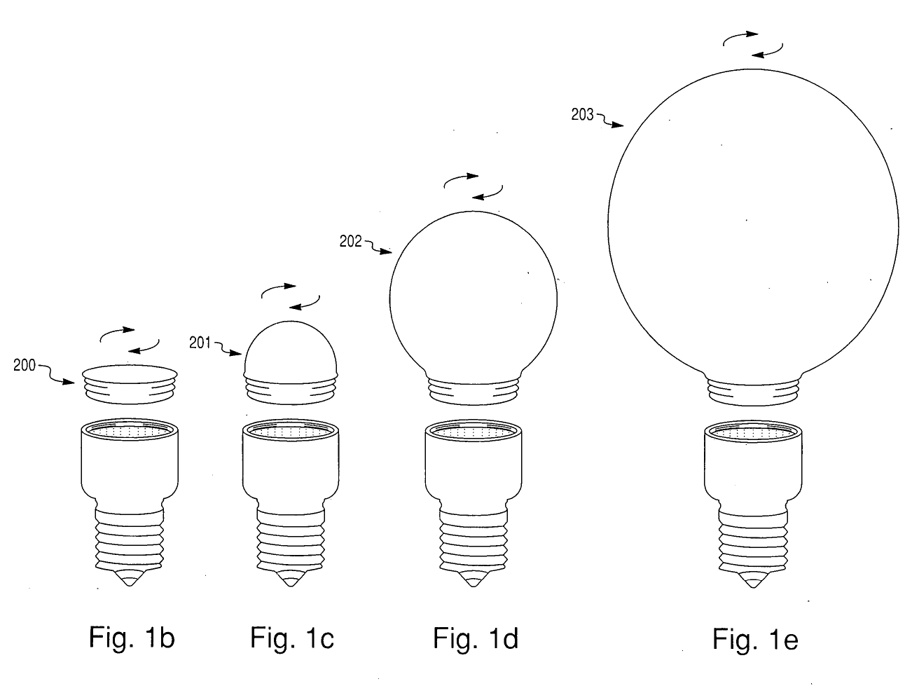

As illustrated in FIGS. 1a, 2a, 3a, and 5 the lighting module (100), containing the LED chips (101), affixed directly to the PCB (102) using conventional chip-on-board methods as known in the art. The PQB (102) is bonded directly to a backer plate/heat spreader (103) manufactured from aluminum, copper, ceramic, or other material with superior heat transfer properties.

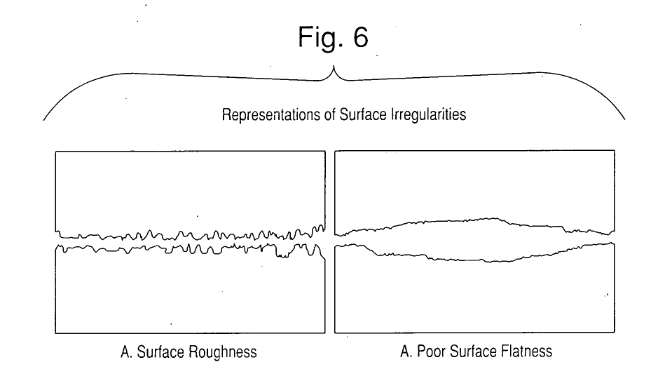

It should be noted that the total surface area of lighting module (100), in particular backer plate/heat spreader (103) can be made smaller or larger as well as thicker to match the thermal requirements associated with the LED chip (101) density and quantity as well as the modules total power requirement in Watts. It should be further noted that the light emission module (100) can be manufactured using multiple planar surfaces that are coupled electrically. Test samples manufactured using a circular, single plane light emission module exhibited uniform light distribution when a diffusing globe was affixed. Lighting module (100) is then affixed to heat sink (105) using a thermally conductive grease, compound, epoxy, adhesive, tape, or elastomer pad (104). This is significant as when two electronic component surfaces are brought together in the prior art designs, less than one percent of the surfaces make physical contact. As much as 99% of the surfaces are separated by interstitial air. Some heat is conducted through the physical contact points, but much more has to transfer through the air gaps. FIG. 6 shows the differences in interstitial air gaps for different surface irregularities. Since air is a poor conductor of heat, it should be replaced by a more conductive material to increase the joint conductivity and thus improve heat flow across the thermal interface.

Test samples of heat sink (105) were manufactured using a zirconium based ceramic compound due to its thermal conductivity and low coefficient of expansion properties however, any suitable material can be used. Notably, the heat sink (105) can be adapted in size, shape and configuration to match the cooling requirements of light emitting module (100) as it is modular in nature, forms a direct thermal pathway between the light emitting diode chips (101) and power couplings (106 and 107) independent of and not subject to spatial limitations, or thermal gain imposed by any encapsulating or enclosing lens or globe. Heat sink (105) can be manufactured in a fluted or finned form to further enhance its thermal transfer capability. It is illustrated in a smooth form for the sake of simplicity only. In addition, heat sink (105) can be modified to accommodate Edison Base, Intermediate Base, or Candelabra Base screw-type power couplings.

Control circuit (106) consists of various electronic components mounted to a PCB then affixed to an underside cavity cast or molded into heat sink (105) by means of a thermally conductive grease, compound, epoxy, adhesive, tape, or elastomer pad (104). Once again the direct thermal pathway from the LED chips (101) through power coupler (107) remains unbroken.

Electrical interface between light emission module (100) and control circuit (106) is made via electrically insulated wires or electrodes of sufficient gauge to handle the power requirements of light emission module (100) without heating. Wires or electrodes are inserted into a cavity (108) cast or molded into heat sink (105) then backfilled with thermally conductive epoxy or compound (104) to purge air gaps that may interrupt thermal flow.

It is important to note that control circuit (106) is located at a point furthest from light emitting module (100) as electrical control circuits of this type contain heat generating electronic components. Although known in the art, various configurations of control circuit (106) are detailed later in this text.

Control circuit (106) is electrically coupled to power coupler (107). Power coupler (107) is then connected directly to heat sink (105) and (optionally) backfilled with thermally conductive epoxy or compound (104) via backfill tube (109), creating a solid, thermally conductive mass and uninterrupted thermal pathway from LED chips (101) to power coupling (107).

Many of the designs contained in the prior art require the use of discreet LED lamps (conventional or surface mount type) mounted to a printed circuit board. In an LED lamp, heat is generated when the lamp is turned on. The heat is generated within the LED chip. The primary thermal path from the LED chip is through the die attach pad (normally cathode side) into the metal lead. The heat flows down the lead (normally cathode side) into the printed circuit board conductor trace. The following equation for discreet LED lamps mounted to heavy metal printed circuit boards should be used.
T_{J}=T_{A}+P_{D}(⊕_{J-P}+⊕_{P-A})=T_{A}+P_{D}(⊕_{J-A})
Where:

T_{J}=LED junction temperature

T_{A}=Ambient temperature

P_{D}=Power dissipation, i.e. I_{F} times V_{f}

⊕_{J-P}=Thermal resistance, junction to cathode pin

⊕_{P-A}=Thermal resistance, pin to air

Pin temperature is defined as the temperature of the soldier joint on the cathode lead on the underside of a 1.6 mm printed circuit when the lamp is mounted at the nominal seating plane. Typical thermal resistance for numerous LED lamps of highest quality is shown in the following Table 1.

TABLE 1
Typical LED Lamp Thermal Resistance

| LED Package | ΘJ-P |
|---|---|
| T1 Lamp | 290° C./W |
| T1¾ Lamp, 18 mil leadframe | 260° C./W |
| T1¾ Lamp, 25 mil leadframe | 210° C./W |
| Subminiature Lamp | 170° C./W |

The above equation can be modified to account for LED lamps mounted above the normal seating plane. For these applications, the heat must flow through a longer path. The additional thermal resistance due to elevating the LED lamp above the printed circuit board is shown in the following Table 2.

TABLE 2
Thermal Resistance due to standoff height

| LED Package | Θs |
|---|---|
| T1 Lamp | 380° C./W, per inch (25.4 mm) |
| T1¾ Lamp, 18 mil leadframe | 280° C./W, per inch (25.4 mm) |
| T1¾ Lamp, 25 mil leadframe | 160° C./W, per inch (25.4 mm) |

The thermal resistance, pin-to-air, can be estimated by measuring the thermal resistance of different sized copper pads (connected to the cathode pin). The thermal resistance, pin to air, as a function of cathode pad area is shown in FIG. 10. It should be noted that FIG. 10 represents a best case scenario wherein additional heat generating elements are not mounted to the circuit board and free air flow is unobstructed by an encapsulating globe.

Thus, the thermal resistance for a discreet LED lamp mounted to a printed circuit can be modeled with the following equation:
⊕_{J-A}=⊕_{J-P}+(⊕_{S})(h)+⊕_{P-A}
Where:

⊕_{J-P}=Thermal resistance from Table 1

⊕_{S}=Standoff thermal resistance from Table 2

H=Height above normal seating plane in inches

⊕_{P-A}=Thermal resistance, from FIG. 10

It is a further object of this invention to match the size, shape, and configuration of the heat sink to the cooling requirements of the light emitting array, independent of spatial limitations imposed by encapsulating lenses, or globes contained in the prior art.

Light emitting array (100) is bonded to heat sink (105) using a thermally conductive grease, compound, epoxy, adhesive, tape, or elastomer pad (104). The size and shape of heat sink (105) can be manufactured smaller, larger, or finned to increase surface area without changing the surface area of light emitting module (100).

In order to increase the total light output of lighting module (100), one of ordinary skill in the art has several options.

Increase LED chip (101) density thus total Wattage

Increase LED chip (101) input current thus total Wattage

As LED chip density and/or input current increases the heat generated by lighting module (100) increases proportionately. It is important to match the LED chip size and configuration with the maximum allowable input current (i-Max) to the intended drive current of the device. LED chips as large as 40 mil×40 mil (1 mm square) are commercially available. These LED chips can be driven upwards of 1,000 mA (DC). A temperature probe attached to heat spreader (103) at point TP1 as shown in FIGS. 1a, 2a, and 3a will verify thermal gain.

Prototype test samples of this new invention were manufactured in its most basic form (FIG. 1a), wherein heat sink (105) was smooth (not finned or fluted) and had a total surface-to-air convection area of 29.5 square inches. The total area of lighting module (100) was 30 mm diameter×4.1 mm thick, including heat spreader (103).

At 4 Watts total power, there was a total luminous output of approximately 200 lumens and temperature probe (TP1) did not exceed 80° C. This enhanced thermal efficiency is attributed in large to the direct thermal pathway formed between LED chip (101) and power couple (107).

The total surface-to-air convection area of heat sink (105) can be dramatically increased by casting the part with a finned surface, without affecting the total footprint size, thus providing adequate cooling of lighting module (100) of greater Wattage and luminous intensity.

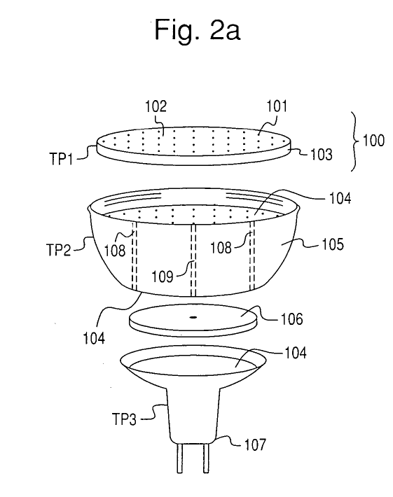

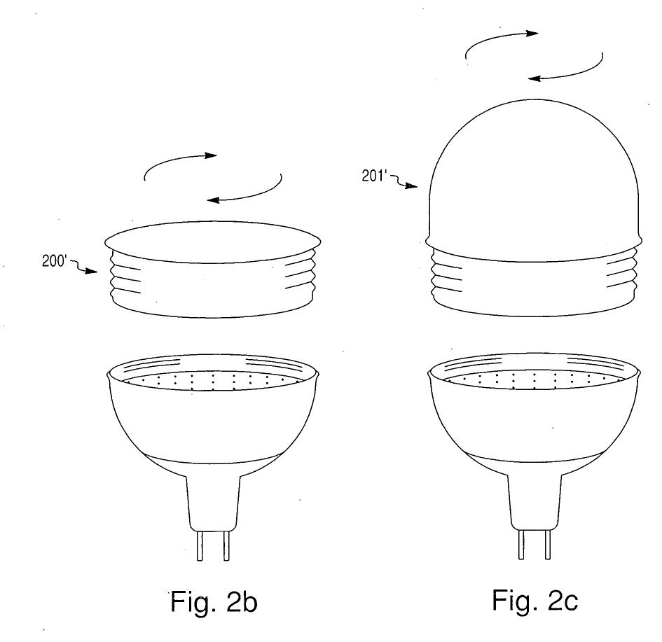

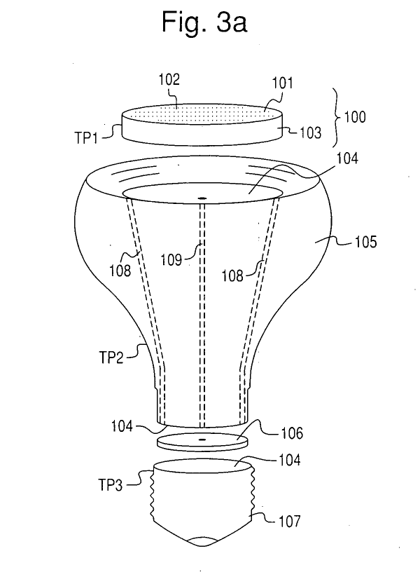

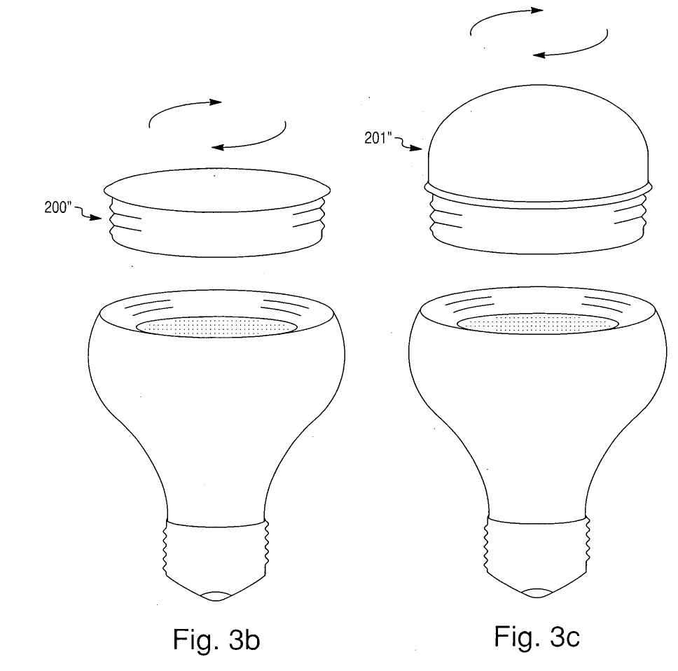

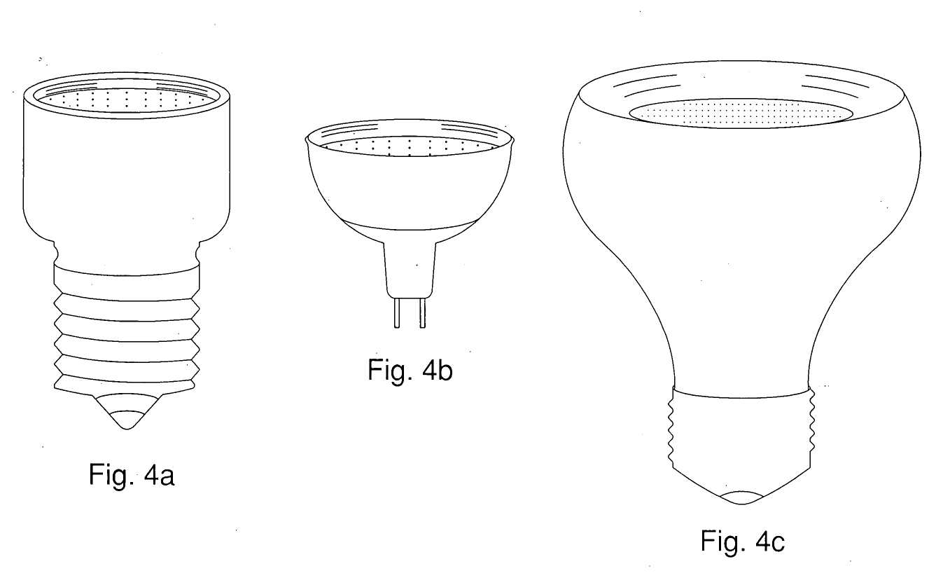

Heat sink (105) can be manufactured in any size, shape, or configuration as shown illustrated in FIGS. 1a, 2a, and 3a, provided its cooling capacity is matched to the total cooling requirements of lighting module (100). For example the flood, or spot light depicted in FIG. 3a has a much larger heat sink area than the R 12 lamp depicted in FIG. 2a, allowing lighting module (100) to have a significantly higher total Wattage, thus greater luminous intensity.

It is a further object of this invention to provide a solid state (LED) lighting device with an easily adjustable light emission pattern. This is accomplished through a system of replaceable lenses, or globes independent of the light emitting device as shown in FIGS. 1b, 2b, and 3b.

FIG. 1b depicts one embodiment of this new invention, a traditional or common “light bulb” as shown in FIG. 1a. Lens (200) can be manufactured of glass, plastic, or other suitable material and simply screws onto threads cast into heat sink (105) as illustrated in FIG. 1a. This lens is primarily flat, can be manufactured clear, opaque clear, colored, or opaque colored and represents a very wide viewing angle as could be used to illuminate the interior of signage, or for backlighting when a very wide emission angle is desired. Lens (201) can also be manufactured of glass, plastic, or other suitable material. The domed portion of this device serves to focus the light emission pattern to any pre-set width as determined by the pitch and height of the focus lens. For example the pitch and height of the domed portion of this lens can be manufactured to provide an emission angle of 30° to be used in applications where a narrow, intense beam of light is desired such as architectural, display, or spot lighting. Lenses 202 and 203 can also be manufactured of glass, plastic, or other suitable material in clear, clear opaque, color clear, or color opaque form and illustrate the easy of interchangeability between globes of various sizes. These globes can be manufactured in an infinite variety of sizes or shapes, including decorative effects such as “cracked glass”, or “beaded glass”. They can serve to diffuse the emitted light for uniform illumination, or provide unique decorative effects. In addition, lenses can be formed in novelty shapes such as fruit or drink containers (for example, soft drink bottles or beer cans) for unique and promotional items.

FIG. 2b depicts another embodiment of this invention, commonly known as an R 12 lamp. Once again lens 200′ represents a wide angle lens to be used when wide, even illumination is desired. Lens 201′ represents a domed or focused lens where the viewing angle is pre-set by the pitch and height of the dome. This application may be desirable in under cabinet lighting as used in kitchens or in retail showcases as an alternative to halogen lamps.

FIG. 3b depicts another embodiment of this invention, commonly known as a flood lamp or spot lamp. Lens 200″ represents the wide emission angle common to a flood light and is interchangeable with lens 201″, representing the focused or narrower angle of a spot lamp.

The different lens configurations and benefits have not been adequately addressed in the prior art and the unique features of this invention will be recognized by one of ordinary skill in the art given the teachings of this new invention.

It is a further object of this invention to provide a solid state (LED) lighting device wherein the LED chips or dice are coupled electrically in a series or series/parallel configuration and powered using a high voltage and high input current scheme. This configuration minimizes the cost and thermal gain associated with excessive intervening circuitry required of low voltage schemes, thus lowering manufacturing cost while providing arrays with greater luminous intensity due to the higher LED drive currents.

This high voltage/high current scheme is unique in that LED arrays or lamps as disclosed in prior art are powered using the following:

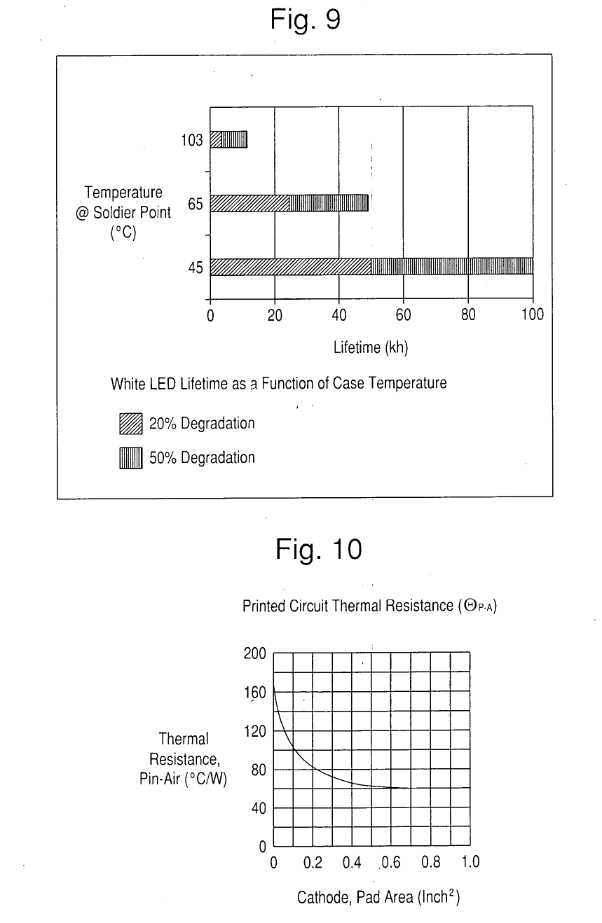

Low Voltage/Low current—This configuration is common to LED arrays or lamps using chip-on-board or discreet LED devices or lamps. Input voltage is converted to low voltage AC or DC then LED lamp input current (normally 20 mA) is limited due to the inherent thermal properties of the LED lamps as shown in Tables 1 and 2 and FIGS. 9-11 in order to avoid catastrophic failure due to elevated junction temperatures.

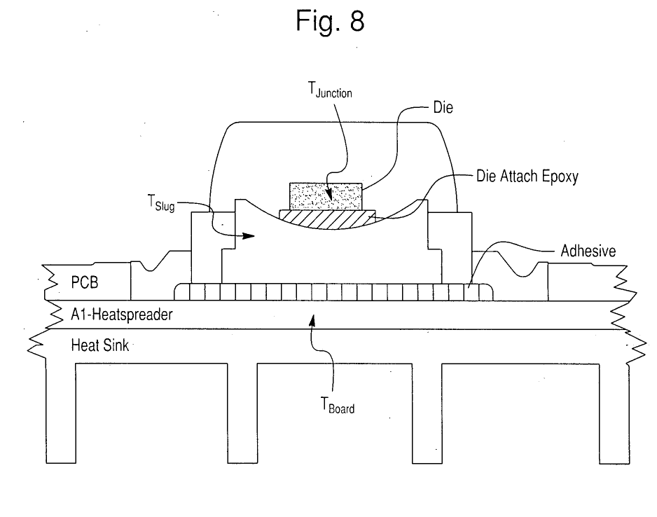

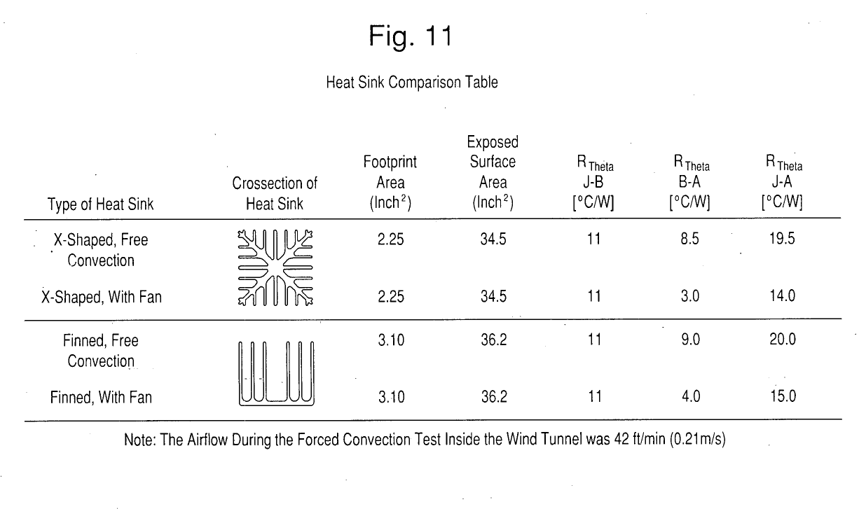

Low Voltage/High Current—This configuration is common to modern high power LEDs, often called power LEDs or emitter diodes as known in the art. The discreet LED lamps house very large LED dice, often 1 mm×1 mm and are driven at a constant, low DC voltage and very high current (upwards of 1,000 mA). External drivers, or power sources are required as well as the necessity to mount each lamp to an external heat spreader, then to an external heat sink as shown in FIG. 11. These devices are commonly used in high brightness LED flashlights or large flat panel arrays for industrial applications. Multiple devices of this type are electrically coupled in parallel. A pictorial example of a high power LED or emitter diode mounted on a heat spreader and heat sink is shown in FIG. 8.

High Voltage/Low Current—This configuration is common to most of the solid state (LED) lighting devices disclosed in the prior art. LEDs are electrically coupled in a series configuration and powered using half-wave (non-rectified) or full wave (rectified) AC voltage. LED lamp input current (normally 20 mA or less) is limited due to the inherent thermal properties of the LED lamps as shown in Tables 1 and 2 and FIGS. 9-10 in order to avoid catastrophic failure due to elevated junction temperatures. Additional care must be exercised when using this configuration as peak lamp current is significantly higher than average lamp current and causes additional thermal gain.

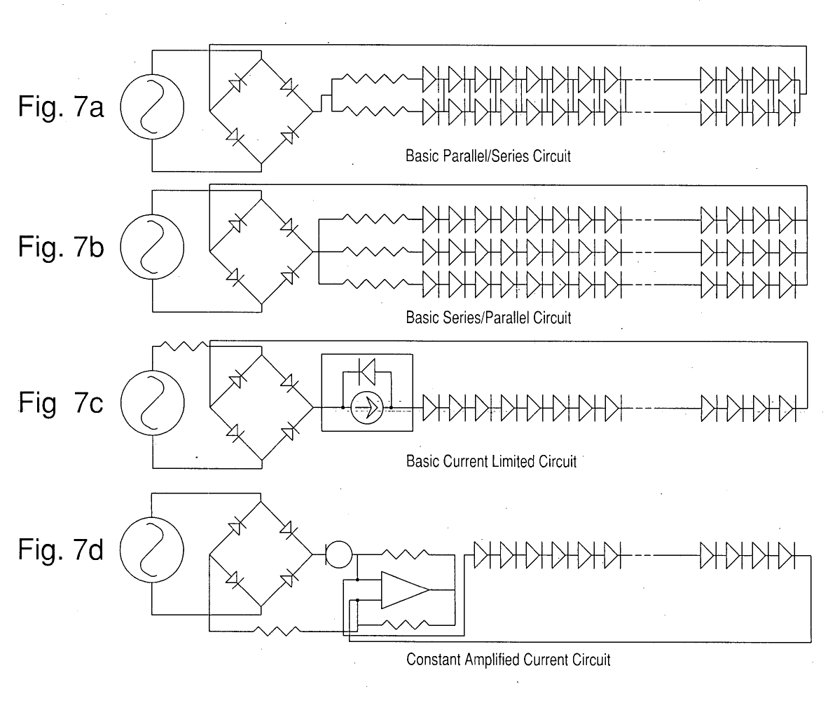

LED chip or dice input current is infinitely adjustable using this high voltage/high current configuration. Once again, the important aspect of this new invention is matching the additional heat generated by driving the LED dice (chips) at high current with the heat dissipating capability of the device as shown in FIGS. 1a, 2a, and 3a and the size and type of LED dice selected (i-Max). Methods of regulating LED input current are known in the art, ranging from simple series resistors through commercially available constant current devices. Several pictorial examples of appropriate circuits are shown in FIG. 7a-7d.

This high voltage/high current drive scheme has not been address in the prior art and the unique features of this invention will be recognized by one of ordinary skill in the art given the teachings of this new invention.

It is a further object of this invention to increase the luminous output and electrical efficiency by utilizing multiple; smaller LED dice as opposed to the large, single LED die used in power LEDs or LED emitter lamps.

Power LEDs (FIG. 8) use large, single LED dice upwards of 1 mm×1 mm in size. Testing has shown the use of multiple smaller LED dice of the same emission area generate higher luminous intensity given the same total power consumption and viewing angle. Moreover, power LEDs require extensive, external heat sink whereas multiple, large LED chips can be utilized in the manufacture of this device. This feature has not been address in the prior art and the unique features of this invention will be recognized by one of ordinary skill in the art given the teachings of this new invention.

It is a further object of this invention to provide a solid state (LED) lighting device free of the spatial limitations imposed by the use of discreet LED lamps and/or encapsulated thermal management as disclosed in the prior art.

The number and density of discreet or surface mount LED lamps as disclosed by prior art is limited by the total surface area of the circuit board housing these devices. This causes severe spatial limitations. The present invention removes those limitations as LED dice or chips (101) are mounted directly to circuit board (102) and clad with heat spreader (103) as shown in FIGS. 1a, 2a, 3a, and 5. The number and density of LED dice (101) is only limited by the thermal properties of the device.

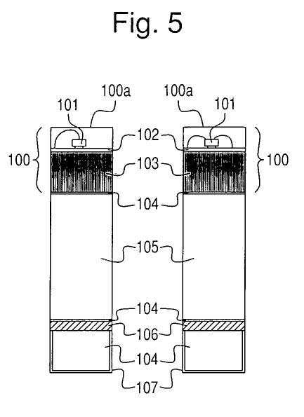

It is a further object of this invention to provide a solid state (LED) lighting device that can be manufactured in an infinite variety of colors as well as white and full spectrum white. This is accomplished through the blending of LED dice of various emission colors. Color adjustable, full spectrum white is easily accomplished by adding sub die of various emission colors to a predominately white (blue or ultraviolet emission dice with phosphor) array, or through the use of a predominately red, blue, green array. Additional color rendering adjustments can be made by tinting the module encapsulating epoxy layer 100a as shown in FIG. 5.

The high voltage/high current configuration of this invention also allows the manufacture of high brightness color changing arrays through the use of multiple series blocks in lighting module (100). Any of the example circuits shown in FIG. 7 can be configured to accommodate multiple series blocks. IC's are commercially available and can be programmed to switch or fade multiple outputs, thus controlling the illumination of the multiple sub die arrays (individual series blocks) in a pre-programmed pattern and can be easily incorporated into control circuit (106).

Color changing can be a random event or can be coordinated so that every lamp powered by the same circuit fades or changed color simultaneously. This can be done by programming a simple counting device into the IC, then counting the crossings of the AC sine-wave as a reference or triggering point.

It is further object of this invention to provide (optional) protection against ESD (Electro Static Discharge) damage to the LED dice during the manufacture and handling of the device. This is accomplished through the installation of a silicone sub die on circuit board (102) and incorporated into lighting module (100).

It is a further object of this invention to provide a qualified testing mechanism or standard for the effectiveness and efficiency of the thermal model and various components used in this new invention. Mathematical formulas for calculating thermal resistance models are known in the art and have been widely published. However, these models should be used as a point of reference only due to wide variations in thermal efficiency of ceramics, heavy metal clad circuit boards and thermal interface materials. In addition, air pockets or poor thermocouple contact introduced during the manufacturing process act as barriers to thermal conductivity and can have a significant impact on the long-term reliability of the lighting device.

Attachment points for temperature probes are labeled as TP1, TP2, and TP3 on FIGS. 1a, 2a, and 3a. The total luminous intensity for lighting module (100) is determined by the size, type, luminous intensity, and quantity of LED dice (101) at a pre-determined input current, or total Wattage of the device. The size, type, and luminous intensity of the LED dice are variables as they generally improve with advances in epitaxial wafer manufacturing, processing, materials, and dicing techniques. Given that lighting module (100) meets the total luminous output desired, the quantified data provided by TP1, TP2, and TP3 are modeled as follows:

A_{(Typ)}=Typical ambient temperature anticipated for the application

A_{(Max)}=Maximum ambient temperature for the application

At A_{(Max)}

TP1≦100° C.

TP2≧80% TP1

TP3≧80% TP2

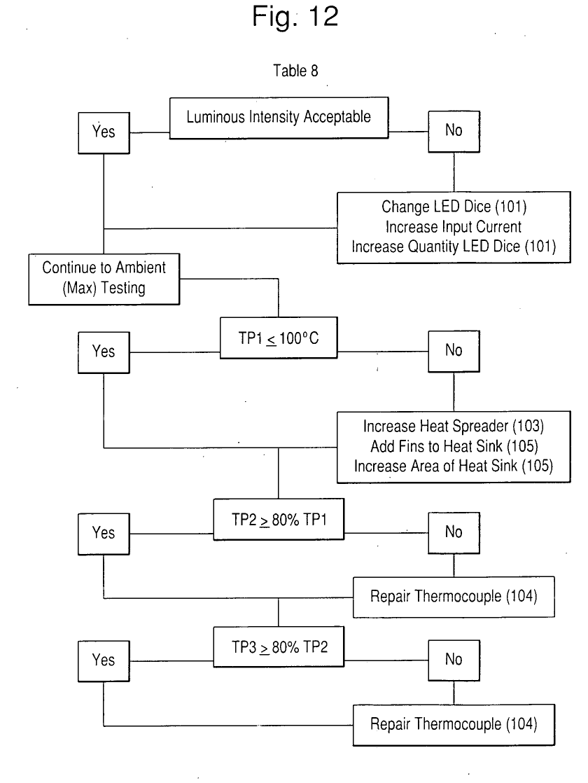

Although straightforward and simple, this model serves as a highly reliable testing and modeling criteria. This is further illustrated in FIG. 12.

It is a further object of this invention to provide a solid state (LED) lighting device that can be mass produced efficiently, at a minimum cost. This is accomplished in large through the high degree of automation applicable to the manufacture of this device as well as its modular design.

Heavy metal clad circuit boards are commercially available and are compatible with automated, high-speed die bonding machinery. Wire bonding of LED dice (101) to circuit board (102) contact pads as shown in FIG. 5 can also be accomplished through the use of automated, high-speed wire bond machinery. Upon completion of the die bonding and wire bonding process, automated testing machinery can probe and illuminate each LED die in order to test the integrity of the die bonding and wire bonding process and electrical connections as well as test the luminous intensity and wavelength of individual LED die at a given input current. Installation of the seal and/or phosphor layer shown in FIG. 5 is also fully automated as is the manufacture of control circuit (106).

Heat sink (105) and power couple 107 are also easily mass produced using automated machinery. Final assembly and packaging of products can be automated, semi-automated, or use manual labor as the final assembly process is not labor intensive.

As illustrated in FIGS. 1a, 2a, 3a, and 5 the lighting module (100), containing the LED chips (101), affixed directly to the PCB (102) using conventional chip-on-board methods as known in the art. The PCB (102) is bonded directly to a backer plate/heat spreader (103) manufactured from aluminum, copper, ceramic, or other material with superior heat transfer properties.

It should be noted that the total surface area of lighting module (100), in particular backer plate/heat spreader (103) can be made smaller or larger as well as thicker to match the thermal requirements associated with the LED chip (101) density and quantity as well as the modules total power requirement in Watts. This is further illustrated in FIG. 12. It should be further noted that the light emission module (100) can be manufactured using multiple planar surfaces that are coupled electrically. Circuitry examples are shown in FIG. 7. Test samples manufactured using a circular, single plane light emission module exhibited uniform light distribution when diffusing globes (FIG. 1b, numbers 202 and 203) were affixed.

Lighting module (100) is then affixed to heat sink (105) using a thermally conductive grease, compound, epoxy, adhesive, tape, or elastomer pad (104). Since air is a poor conductor of heat, it should be replaced by a more conductive material to increase the joint conductivity and thus improve heat flow across the thermal interface.

Control circuit (106) consists of various electronic components mounted to PCB then affixed to an underside cavity cast or molded into heat sink (105) by means of a thermally conductive grease, compound, epoxy, adhesive, tape, or elastomer pad (104). Once again the direct thermal pathway from the LED chips (101) through power coupler (107) remains unbroken.

Electrical interface between light emission module (100) and control circuit (106) is made via electrically insulated wires or electrodes of sufficient gauge to handle the power requirements of light emission module (100) without heating. Wires or electrodes are inserted into a cavity (108) cast or molded into heat sink (105) then backfilled with thermally conductive epoxy or compound (104) to purge air gaps that would interrupt thermal flow.

It is noted that control circuit (106) is located at a point furthest from light emitting module (100) as electrical control circuits of this type contain heat generating electronic components. Various schematic configurations of control circuit (106) and lighting module (100) are shown in FIG. 7. Intentionally omitted from FIG. 7 is an (optional) Integrated Circuit (IC) to control the color changing or color fading option that may be desired in certain applications and is fully described in the text of this new invention.

Control circuit (106) is electrically coupled to power coupler (107). Power coupler (107) is then connected directly to heat sink (105) and (optionally) backfilled with thermally conductive epoxy or compound (104) via backfill tube (109), creating a solid, thermally conductive mass and uninterrupted thermal pathway from LED chips (101) to power coupling (107).

FIG. 7 contains several schematic diagrams wherein LED chip or dice input current is infinitely adjustable and uses the high voltage/high current drive configuration in accordance with the present invention. Methods of regulating LED input current are known in the art, ranging from simple series resistors through commercially available current limiting devices such as FET's and current limiting diodes, through more complex constant current devises such as amplified current limiting diode circuits.

While specific embodiments of the invention have been shown and described in detail to illustrate the application of the principles of the invention, it will be understood that various changes in form and detail may be made therein without departing from the spirit and scope of the present invention as described.

What is claimed is:

1. A solid-state lamp, comprising:
a lighting module (100) including a printed circuit board (102), at least one light emitting diode (LED) chip (101) affixed directly to the printed circuit board (102), and a backer plate (103) contacting said printed circuit board, said backer plate (103) dissipating heat from generated by at least one of said chip (101) and said printed circuit board (102);
a heat sink (105) affixed to said backer plate (103) of said lighting module (100) in a manner to reduce interstitial air gaps between the heat sink (105) and said backer plate (103);
a control circuit (106) mounted to said heat sink (105) opposite said printed circuit board (102);
an electrical interface electrically connecting said lighting module (100) to said control circuit (106),
a power coupler (107) electrically connected to said control circuit (106).

2. The lamp according to claim 1, wherein said electrical interface passes through said heat sink (105).

3. The lamp according to claim 1, wherein said power coupler (107) is connected directly to said heat sink (105).

4. The lamp according to claim 1, wherein a solid, thermally conductive mass creates an uninterrupted thermal path from said at least one light emitting diode (LED) chip (101) to said power coupler.

5. The lamp according to claim 1, further comprising a lens for transmitting light from said at least one light emitting diode (LED) chip.

6. The lamp according to claim 1, further comprising a seal or phosphor layer encapsulating said LED chip.

7. The lamp according to claim 1, wherein said at least one light emitting diode (LED) chip comprises a plurality of LED chips coupled in series or a series/parallel configuration and powered using a high voltage and high input current scheme.

8. The lamp according to claim 1, further comprising a silicone sub die disposed on the printed circuit board (102) for protection against electrostatic discharge damage to the at least one LED chip.

9. The lamp according to claim 1, wherein a surface area of said backer plate (103) may be varied to accommodate thermal requirements associated with said at least one LED chip.

10. The lamp according to claim 1, wherein said the lighting module (100) is manufactured using multiple planar surfaces that are coupled electrically.

11. The lamp according to claim 1, wherein said lighting module (100) is affixed to said heat sink (105) using at least one of a thermally conductive grease, compound, epoxy, adhesive, tape, and an elastomer pad (104).

12. The lamp according to claim 1, wherein said electrical interface between said lighting module (100) and said control circuit (106) is made via electrically insulated wires or electrodes of sufficient gauge to handle the power requirements of light emission module (100).

13. The lamp according to claim 12, wherein said wires or electrodes are inserted into a cavity (108) cast or molded into heat sink (105) then backfilled with thermally conductive epoxy or compound (104) to purge air gaps that would interrupt thermal flow.

14. The lamp according to claim 1, wherein said backer plate (103) is manufactured from a material selected from the group consisting of aluminum, copper and ceramic.
